(19) United States
(12) Patent Application Publication
(10) Pub. No.: US 2008/0137480 A1
(43) Pub. Date: Jun. 12, 2008

(54) Method of Building a Subsurface Velocity Model

(75) Inventor: Malcolm Donald MacNeill, Perth (AU)

Correspondence Address: EDELL, SHAPIRO & FINNAN, LLC, 1901 RESEARCH BOULEVARD, SUITE 400, ROCKVILLE, MD, 20850, US

(73) Assignee: Woodside Energy Limited, Perth (AU)

(21) Appl. No.: 11/567,831

(22) Filed: Dec. 7, 2006

(51) Int. Cl. G01V 1/00

(52) U.S. Cl. 367/73

(57) ABSTRACT

A method is provided for building a subsurface velocity model from a plurality of bins of marine acquired seismic traces of the subsurface.

### CROSS REFERENCE TO RELATED APPLICATIONS

This application incorporates by reference in their entireties the following co-pending U.S. patent applications: U.S. patent application Ser. No. 11/560,057, entitled “Marine Seismic Data Acquisition”, and filed Nov. 15, 2006; and U.S. patent application Ser. No. 11/560,111, entitled “Multi-Azimuth Marine Seismic Data Acquisition System and Method”, and filed Nov. 15, 2006.

### FIELD OF THE INVENTION

The present invention relates to the field of velocity model building to enable imaging of marine seismic data.

### BACKGROUND OF THE INVENTION

The acquisition of 3-D marine seismic data is conventionally generated by a marine vessel towing a plurality of streamers parallel to a sail line. It is not unusual for the streamers to be spaced up to 100 m apart and be 6,000 m long. Each streamer may have several hundred (e.g. 480) hydrophones. For a typical bin size of 25 m×12.5 m this data acquisition method will provide 60 seismic traces per bin.

Having acquired the data standard techniques can be used to build a velocity model of the subsurface and thus enable depth imaging of the subsurface.

Velocity model building is the process of constructing a 3D representation of the speed of acoustic waves through the subsurface. This is the crux to being able to attain a good image which allows for a structural understanding of the subsurface. Having made all the necessary kinematic corrections to the data then it's dynamic behaviour with respect to the angle of propagation through a layer of interest can lead to fluid prediction (aka AVA or AVO)

There are effectively 3 types of velocity model that can be construed

### 1. Hard Layer model

This is where a model is made up of a series of layers between interfaces where the velocity behaviour within a specific layer is constrained to some predefined relationship such as
   a) Layer Velocity V=constant (eg 1500 m/s for water, or 4500 m/s for salt)
   b) Layer velocity V=V₀+kZ where Vₒ is a velocity map in (x,y) either at z=0 or at an upper interface and k is the velocity gradients (this is useful for defining compaction gradients)

### 2. Gridded Model

This is a model which is split into cells of Δx, Δy and Δz where each cells has an independent value, (eg Δx=100 m, Δy=100 m and Δz=50 m). This naturally allows the velocity model to incorporate and adapt to more complex geological formations as normally occur in the real world.

### 3. Hybrid Model

This is simply a merging of the above two types where the hard-layer model may define a water column and salt diapers, and a gridded model may define surrounding sediment.

All velocity model building methods basically have the same basic workflow.

### 1. Migration

Attempt to image the data making some first guesses.

### 2. Analyse

Measure the errors in the estimates.

### 3. Update

Adjust the initial starting model in accordance with the measured errors.

Embodiments of this invention adopt this general workflow but utilise an alternative method for analysing the errors in the estimates.

### Migration

Migration is the process of relocating measured reflection energy from a seismic signal to it subsurface reflection point.

There are a number of different migration algorithms being used in the industry from Kirchhoff migration to a whole suite of wave-equation migration (WEM's) to recent Reverse Time Migrations (RTM) and others. Kirchhoff migration is without a doubt the flagship and is used 95% of the time and shall be main one talked hereafter.

Kirchhoff migration is an inverse backscattering method that relies on the statistical constructive interference of signal and the destructive interference of noise. It is a two step operation that first upward projects or ray-traces from every depth point to the surface and builds a travel-time table of potential ray paths to surface locations. It then sums the samples for every surrounding trace at a time based on their source and receiver locations as defined by the travel timetable.

### Analyse

The normal method of analysing is to review the migrated gathers. In theory if the correct velocity has been used then all energy relating to a specific event will have been put back in its correct position and will have the same depth regardless of offset. This is otherwise termed as a “flat” gather. If it is not “flat” then there is some residual error in the velocity model.

There are scan methods currently employed however they all rely on the gathers being flat and thus giving optimal stack power and amplitude where the correct velocity exists. Thus, all analysing methods are either looking for flat gathers or the immediate effect of being flat (stronger amplitude).

The velocity model is updated using seismic reflection tomography, otherwise known as “travel time inversion”. There are a number of modes for using tomography for updating a velocity model with residual error measurements made during the analysis stage mentioned above. These really fall into two main categories:

1. 1D
This does not take into account any neighbouring contribution and solves only in a “vertical” sense.

2. 3D
This involves all the neighbouring results to weight the overall solution in a collective a real manner.

Applicant has developed a method for acquiring 3-D marine seismic data which has the benefits of being substantially simpler and less expensive than a multi-streamer survey of the prior art although it has a disadvantage in providing typically 5-10 seismic traces per event in a bin in comparison with the 60 traces per event per bin for the prior art 3-D multi streamer survey. In brief, Applicant's method for acquiring the 3-D seismic data comprises sailing a vessel along a sail line towing one or more seismic streamers where at least a portion of one streamer is maintained at an angle to the sail line whilst seismic data is being acquired. This angle may range from 10° to 80°. This data acquisition method is termed “Recon 3D”.

Due to the substantially reduced data volume (i.e. number of traces per bin) insufficient data is acquired to enable the building of a velocity model using the prior art techniques.

The present invention was developed to enable the building of a velocity model with substantially reduced initial data input. While embodiments of the present invention are ideally suited to Applicant's above mentioned data acquisition technique, it may also be used with data acquired using the prior art conventional 3-D marine data acquisition techniques by simulating the Recon 3D offset distribution.

### SUMMARY OF THE INVENTION

According to the present invention there is provided a method of building a subsurface velocity model comprising:
(a) providing a plurality bins each of which comprises a plurality of marine acquired seismic traces of the subsurface, each bin comprising at least one set of seismic traces where the or each set of seismic traces has a partial range of offsets;
(b) providing a starting velocity model for the subsurface;
(c) migrating the binned traces using the starting velocity model and a series of further velocity models each of which is varied from the starting model by a predetermined amount to produce migrated output gathers;
(d) processing and scanning the migrated output gathers to detect discontinuities or variations arising from the application of each of the velocity models to the traces;
(e) picking the velocity which provides a zero or minimal discontinuity or variation for any particular location in the subsurface;

(f) building the velocity model by updating the starting model using the picked model; and
(g) repeating steps (c)-(f) for each of a plurality of locations in the substrata, but with the starting model replaced with the updated starting model.

In one embodiment of the method the bins are arranged in respective common cross-lines. In this embodiment step (d) may comprise stacking the migrated output gathers for a common cross-line and scanning the stacked migrated outputs for discontinuities.

In an alternate embodiment the bins are arranged in an in-line direction and located in an overlap area of two adjacent sail lines. In this embodiment step (a) may comprise dividing the sample in each bin into two separate groups of near offset traces and far offset traces. Additionally step (c) may comprise migrating divided bins produces a pair of migrated output gathers for each bin. Further step (d) may comprises stacking the migrated output gathers for each pair of migrated output gathers to produce a pair of corresponding migrated stacks and correlating the pair of migrated stacks with each other to produce a time discontinuity.

In each of the embodiments step (a) may comprise acquiring the traces from acoustic receivers in a streamer having at least a portion of its length disposed at an angle of greater than 15 degrees to the sail line.

The scanning may be performed by visually scanning an image derived from the migrated output gathers for the discontinuities.

However in an alternate embodiment the scanning may be performed automatically by use of a mathematical algorithm.

In one embodiment of the method step (a) may comprise the at least one set of seismic traces is provided by sailing a vessel along a sail line whilst towing one or more streamers, each streamer including at least two hydrophones wherein the or each streamer is maintained substantially parallel to the sail line to produce for each bin a full offset range of seismic traces, and selecting a subset of the full range of seismic traces as each of the at least one set of seismic traces.

### BRIEF DESCRIPTION OF THE DRAWINGS

Embodiments of the present invention will now be described by way of example only with reference to the accompanied drawings in which:

FIG. 1 depicts an aerial view of an arrangement for acquiring seismic data that may be used to build a subsurface velocity model in accordance with an embodiment of the present invention;

FIG. 2 illustrates three sail lines traversed by a vessel depicted in FIG. 1 together with a representation of the signals required in various bins in the area traversed by the vessel;

FIG. 3 depicts the work flow adopted in an embodiment of the present method for building a velocity model;

FIG. 4 is a representation of the method for building a velocity model using cross line data;

FIG. 5 illustrates the effects of migration on the cross line data utilizing different velocity models;

FIG. 6 illustrates three sail lines traversed by a vessel depicted in FIG. 1 together with a representation of the signals required in various bins in the area traversed by the vessel;

FIG. 7 depicts an embodiment of the present method for building a velocity model using inline data; and,

FIG. 8 is a graphic representation of migration stacking and correlation steps used in the method depicted in FIG. 7.

### DETAILED DESCRIPTION OF THE PREFERRED EMBODIMENTS

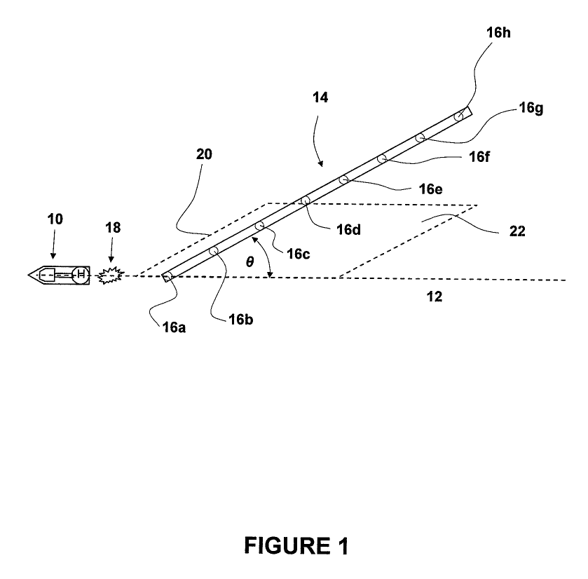

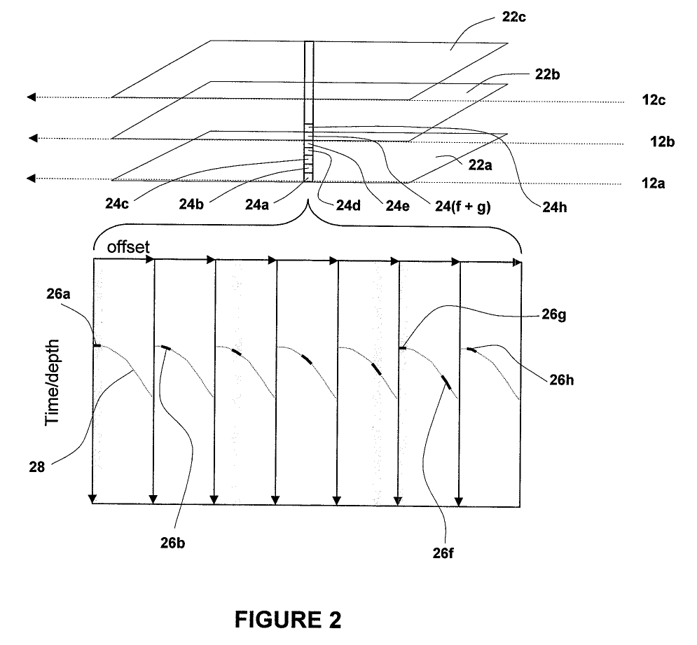

Embodiments of the present invention are described with reference to Applicant's method of acquiring seismic data described in Applicant's cross referenced application Ser. Nos. 11/560,057 and 11/560,111. This method of acquiring seismic data is briefly summarised below with reference to FIGS. 1 and 2.

FIG. 1 illustrates a vessel 10 sailing along a sail line 12 and towing a seismic streamer 14 which includes a number of evenly spaced hydrophones 16a-16h (hereinafter referred to in general as “hydrophones 16”). An acoustic source 18 is also towed by the vessel 10 emits acoustic waves which are reflected at one or more subsurface interfaces to produce seismic signals that are detected by the hydrophones 16. The streamer 14 has at least a portion of its length (although in the illustrated embodiment its whole length) maintained at an angle θ to the sail line 12. The angle θ can lie between 10° to 80°.

The line 20 in FIG. 1 illustrates the leading edge of an area 22 for which seismic signals are collected by the hydrophones 16. On the assumption that the vessel 10 maintains a steady bearing, the edge 20 is the leading edge of a parallelogram shaped area 22a depicted in FIG. 2.

FIG. 2 illustrates the total area for which seismic signals are collected when the vessel 10 is sailed along three parallel sail lines 12a, 12b and 12c. In this particular embodiment it will be noted that mutually adjacent areas overlap in a cross line direction. That is the areas 22a and 22b overlap along the longitudinal edges in the cross line direction, as do areas 22b and 22c.

FIG. 2 also illustrates a plurality of bins 24a-24g (hereinafter referred to in general as “bins 24”). Bins 24a-24e all lie solely in the area 22a. Bin 24f for which data is acquired while the vessel 10 sails along sail line 12a is in the overlap region between areas 22a and 22b. Bin 24g which overlies bin 24e is also in the overlap region between areas 22a and 22b but the seismic signals for this bin are acquired while the vessel 10 is sailed along sail line 12b. Bin 24h contains seismic data solely for the area 22b and is acquired while the vessel 10 sails along sail line 12b.

The break out area in FIG. 2 is representative of the seismic traces for the bins 24. The vertical axis is indicative of time or depth with the horizontal axis being representative of offset. It will be seen that for bin 24a, several seismic traces 26a are captured by hydrophone 16 for an event 28. The traces 26a have a small or near offset. For the bin 24b, again only a small number of seismic traces 26b are captured for the event 28 but with increased offset. This pattern continues for bins 24c, 24d and 24e which contain traces 26c, 26d and 26e respectively and which have an increasing offset range.

Bins 24f and 24g include respective seismic traces for the same event 28 but the traces for bin 24e are far offset traces, while the traces for bin 24g are near offset traces as they are acquired along the second sail line 12b. As the bins 24f and 24g represent the same area they are treated as a single bin which has both near and far offset data. Bin 24h comprises seismic traces 26h which have greater offset than the traces 26g.

It will also be noted from FIG. 2 that not only do the offsets increase in the cross line direction for seismic traces acquired along any particular sail line 12 but also that the range of offsets for each bin do not overlap.

The data acquired by this method does not sufficient traces to use traditional velocity building methods to enable imaging of the sub strata.

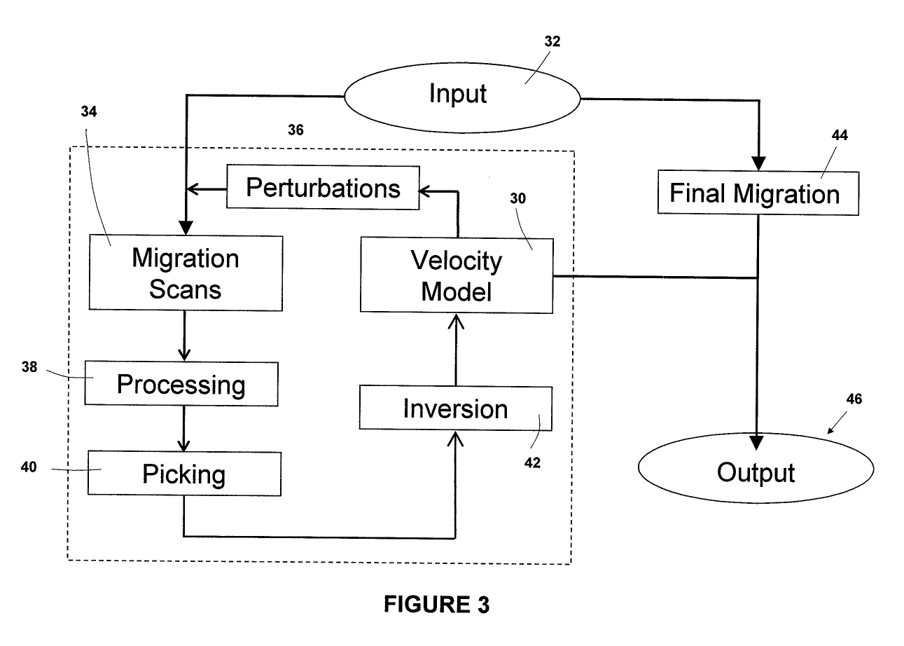

FIG. 3 depicts the general workflow for building a velocity model in accordance with embodiments of the present invention. The method comprises providing a starting velocity model 30 for the subsurface. This model may be based on previous velocity models or surveys of the subsurface; information derived from wells in the subsurface or a geophysicists' or other parties' knowledge of the subsurface. The data provided as an input 32 to the method comprises the binned seismic traces. The traces are those derived from the data acquisition method described in Applicant's cross referenced applications and described in brief in relation to present FIGS. 1 and 2. However, the input 32 may also comprise a subset of full offset traces derived by conventional 3-D seismic surveys where the subsets are selected as gathers for a partial range of offsets for mutually adjacent bins where the offsets in each range increase. This in effect provides a simulated Recon 3D data set or offset distribution.

The traces provided in the input 32 are migrated at 34 using the starting model 30 and a series of perturbed models 36 based on the starting model 30. The perturbed velocity models 36 may comprise for example four additional velocity models all based on the starting model 30 but with different percentile variations. For example, the perturbed models may be based on the starting model 30 with the velocity fields changed by plus and minus 5% and plus and minus 10%. It should also be recognised that more (or indeed less) perturbed velocity models may be used and the variations between the velocity fields and the starting field may use different percentage variations of the velocity field such as 1%, 2% or 3%. In addition, the variations in velocity field between the perturbed models need not vary linearly.

The migrated output gathers derived from the migration scans 34 are processed at 38. The purpose of the processing is to generate discontinuities on the basis of the migrated output gathers. At step 40 the velocity model which produced a zero or at least minimal discontinuity after the processing stage 38 is picked or selected as the velocity model providing best results for that particular location in the substrata. The starting model 30 is then updated via an inversion process 42 using the picks, as above. The updated velocity model 30 is then used as the fresh starting model for the perturbed models at 36. The process is then repeated for a fresh set of input data until all of the seismic traces for all of the bins in the surveyed area are processed. At that time a final velocity model is built and then used for a final migration at step 44 for all of the seismic traces. The final migration process provides an output 46 which could comprise for example a 3-D image of the subsurface.

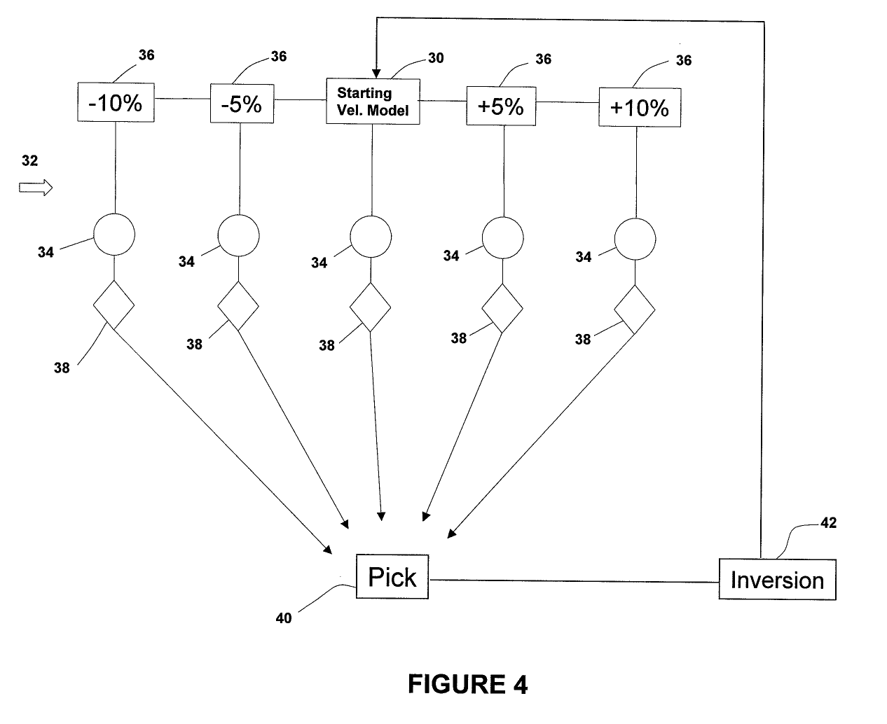

The above described method for building a velocity model may be utilised for both crossline gathers or inline gathers. The main difference between the workflow is in relation to the processing 38. An embodiment of the method as applied to cross line gathers is described in more detail with reference to FIGS. 4 & 5.

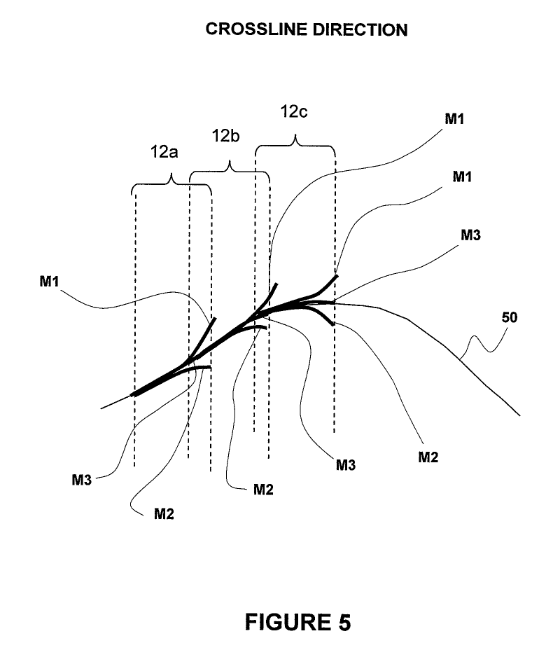

FIG. 4 depicts the work flow of FIG. 3 in an alternate fashion and uses the same reference numbers to denote the same processes. The starting velocity model 30 is initially derived and then four perturbed or further velocity models 36 are derived based on the starting model 30 but with predetermined variations in their velocity fields. Here the variations are illustrated as plus and minus 5% and plus and minus 10%. With reference to FIG. 2, the gathers in the bins 24 are used as the inputs 32 which are migrated by migration scans 34 utilising each of the velocity models 30, 36. The migration process moves the time based seismic traces to their correct depth location. The migrated output gathers are then stacked at process 38. The stacked output for the cross line bins 24 for each of the sail lines 12 are depicted in FIG. 5. In this example it is assumed that the reflector event of interest in the substrata is in the general form of an anticline 50.

FIG. 5 depicts the stacked migrated outputs for each of the sail lines 12a, 12b and 12c. Three stacked migrated outputs M1, M2 and M3 are shown for each of the sail lines 12. The stacked migrated outputs M1, M2 and M3 are indicative of the effect of the different velocity models during the building process. It will be seen that both the migrated outputs M1 and M2 deviate from the event 50 and are discontinuous with a near offset end of the migrated stacked output of an adjacent sail line. The stacked migrated output M1 is indicative of the velocity model used to derive that stacked output as being too slow, while stacked migrated output M2 is indicative of the velocity model used to derive that output is being too fast.

The stacked velocity output M3 is the preferred velocity model for the corresponding input data as it provides a zero or minimal discontinuity with the near offset end of the stacked migrated output for the adjacent sail line 12b. Thus the velocity model used to derive the stacked output gather M3 for the sail line 12a is used as the velocity model to update the starting model of event 50. This process is repeated for the gathers in the bins 24 for each of the sail lines 12 so that the starting velocity model is continually updated. This is of course also repeated for all of the bins in the surveyed total area. Once the process is complete, a final velocity model is built. All of the binned seismic traces may then be migrated in the final migration process 44 shown in FIG. 3 using the final velocity model to produce the output 46.

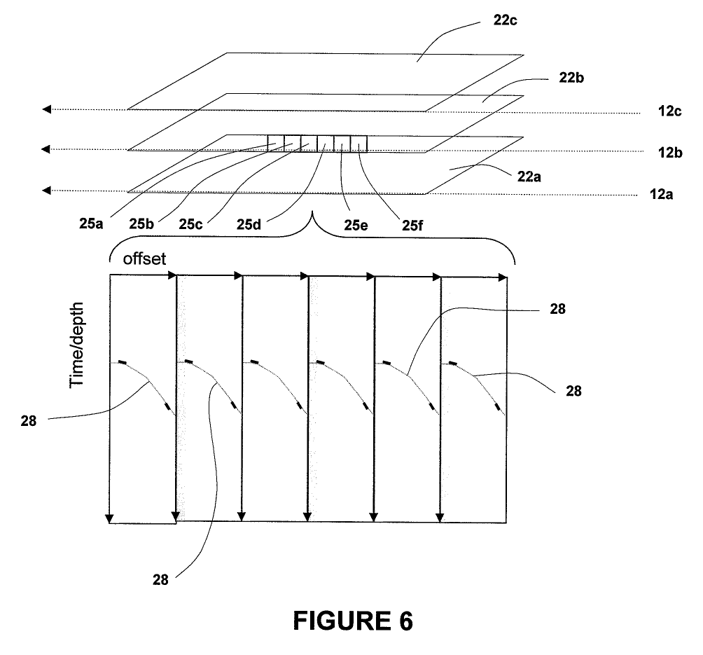

In an alternative embodiment, in-line bins rather than cross-line bins can be used to build the velocity model. This embodiment is depicted in FIGS. 6 to 8. FIG. 6 depicts the typical offset distribution in the inline embodiment of the present invention. It will be noted that the inline bins 25 lie in the overlap region between adjacent areas 22. Specifically in FIG. 6 the bins 25a-25f lie in the overlap region between areas 22a and 22b. It will be noted from FIG. 2 that when a bin lies in the overlap area between adjacent sail lines the bin contains both near offset traces and far offset traces. The near offset traces are derived from the sail line 12b while the far offset traces are derived from sail line 12a. Thus in the breakout area in FIG. 6 each bin is depicted as having a small range of near offset traces and a small range of far offset traces for the event 28.

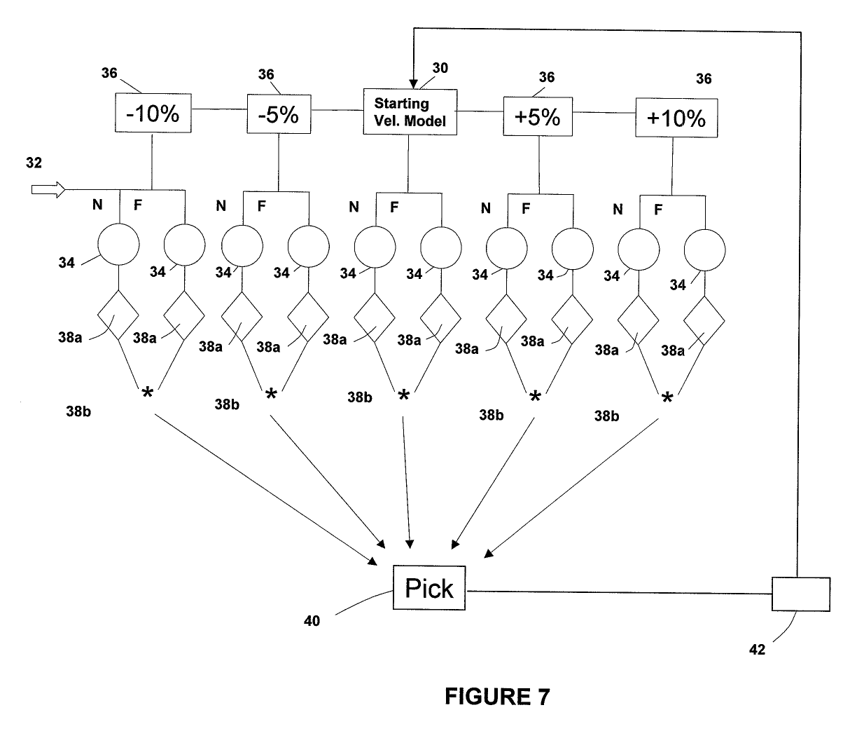

The method for building the velocity model using the inline bins follows the same general work flow as depicted in FIG. 3 and is shown in an alternate manner in FIG. 7. In this embodiment a starting velocity model 30 is derived in the same manner as described with reference to FIGS. 3 and 4, as are the perturbed velocity models 36. The seismic traces from each bin 25 which are used as the input 32 is however now divided into a group of near offset traces N and far offset traces F. Each group of near and far offset traces N and F are migrated at 34 using the velocity models 30, 36. The respective migrated outputs are then each separately stacked at 38a and the separate stacks are then further processed at 38b by a correlation operation. Depending on the accuracy of the velocity model 30, 36, the correlation operation will produce discontinuities in the form of a time shift.

Specifically, if the velocity model used for the migration is too slow a relative negative time shift is obtained from the correlation. On the other hand if the velocity model is too fast a relative positive time shift is obtained. The more accurate the velocity model the smaller the time shift, with the time shift converging to zero when the velocity model is correct. Thus, in the pick step 40 in FIG. 7, the velocity model that produces a zero time shift or a minimal time shift is selected as the velocity model used in the inversion process 42 to update the starting model 30.

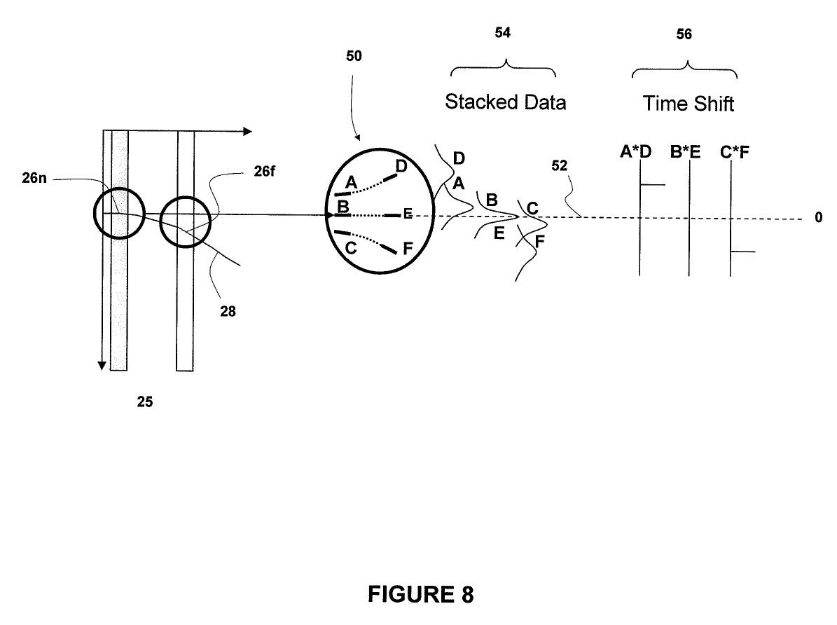

The far left-hand side of FIG. 8 depicts the seismic traces in a bin 25 as comprising a group of near offset traces 26n and a group of far offset traces 26f, for an event 28. These traces are migrated separately using different velocity models 30, 36 and providing different migrated outputs for each of the velocity models. These different outputs are depicted in the circled region 50 in FIG. 8. When the near offset traces 26n are migrated using a velocity model that is too slow the migrated output (A in region 50) tend away from the straight line 52. However the effect on the far offset traces 26f is more pronounced because the far offset traces, by definition, have a longer travel time. This migration then produces an output as depicted at D in the migrated outputs 50.

Conversely, if the velocity model chosen is to fast then for the near offset traces 26n, the migrated output 50 will deviate to some extent the line 52 as depicted by the migrated output C, but for the far offset traces 26f, this deviation is more pronounced as shown by the migrated output F.

When the velocity model chosen is correct or close to being correct, then the migrated outputs for both the near offset traces 26n and the far offset traces 26f will be close to or on the line 52, as depicted by migrated outputs B and E in the migration outputs 50.

Portion 54 of FIG. 8 depicts the result of stacking the migrated outputs for the near and far offset traces 26n and 26f. Thus, in portion 54 the wavelet or curve A depicts the stacked migrated output for the near offset traces 26n using a velocity model that is too slow while wavelet D depicts the stacked migrated output for the far offset traces 26f using a velocity model that is too slow. Wavelets C and F depict the stacked migrated outputs for the near offset traces 26n and far offset traces 26f respectively using the velocity model that is too fast, while overlapping wavelets B and E depict the stacked migrated output for the near and far offset traces 26n and 26f respectively using a velocity model that is correct.

The result of correlating the stacked migrated outputs for the near and far offset traces 26n and 26f for each of the velocity models is shown in section 56 of FIG. 8. The correlation of the stacked migrated outputs A and D provides a negative time shift relative to a zero datum line. The correlated stacked outputs C and F produces a positive time shift. However, correlating the stacked migrated outputs B and E produces a zero time shift. This is indicative that the velocity model used in the migration process that produced the migrated outputs B and E is the velocity model that should be picked for the inversion process and subsequent updating of the starting model 30.

It should be recognised that one benefit of this embodiment of the invention is that the detection of the minimum or zero time shift can be achieved by way of a relatively simple mathematical algorithm. This enables a substantially automated process for sequentially updating and subsequent building the velocity model.

In the claims of this application and in the description of the invention, except where the context requires otherwise due to express language or necessary implication, the words “comprise” or variations such as “comprises” or “comprising” are used in an inclusive sense, i.e. to specify the presence of the stated features but not to preclude the presence or addition of further features in various embodiments of the invention.

It is to be understood that, if any publication is referred to herein, such reference does not constitute an admission that the publication forms a part of the common general knowledge in the art, in Australia or any other country.

What is claimed:

1. A method of building a subsurface velocity model comprising:
(a) providing a plurality of bins, each of which comprises a plurality of marine acquired seismic traces of the subsurface, each bin comprising at least one set of seismic traces where each set of seismic traces includes a partial range of offsets;
(b) providing a starting velocity model for the subsurface;
(c) migrating the binned traces using the starting velocity model and a series of further velocity models, each of which is varied from the starting model by a predetermined amount to produce migrated output gathers;
(d) processing and scanning the migrated output gathers to detect discontinuities or variations arising from the application of each of the velocity models to the traces;
(e) picking a velocity that provides a zero or minimal discontinuity or variation for any particular location in the subsurface;
(f) building a velocity model by updating the starting velocity model using the picked velocity; and
(g) repeating steps (c)-(f) for each of a plurality of locations in the subsurface, wherein the starting model is replaced with the updated starting model.

2. The method according to claim 1, wherein the bins are arranged in respective common cross-lines.

3. The method according to claim 2, wherein step (d) comprises stacking the migrated output gathers for a common cross-line and scanning the stacked migrated outputs for discontinuities.

4. The method according to claim 1, wherein the bins are arranged in an in-line direction and are located in an overlap area of two adjacent sail lines.

5. The method according to claim 4, wherein step (a) comprises dividing the sample in each bin into two separate groups of near offset traces and far offset traces.

6. The method according to claim 5, wherein step (c) comprises migrating divided bins to produce a pair of migrated output gathers for each bin.

7. The method according to claim 6, wherein step (d) comprises stacking the migrated output gathers for each pair of migrated output gathers to produce a pair of corresponding migrated stacks and correlating the pair of migrated stacks with each other to produce a time discontinuity.

8. The method according to claim 1, wherein step (a) comprises acquiring the traces from acoustic receivers in a streamer having at least a portion of its length disposed at an angle of greater than 15 degrees to the sail line.

9. The method according to claim 1, wherein the scanning is performed by visually scanning an image derived from the migrated output gathers for the discontinuities.

10. The method according to claim 1, wherein the scanning is performed automatically by use of a mathematical algorithm.

11. The method according to claim 1, wherein step (a) comprises acquiring the seismic traces from a plurality of sail lines, where the sail lines overlap in the cross-line direction.

12. The method according to claim 1, wherein, in step (a), the seismic traces are acquired by sailing a vessel along the sail line while towing one or more streamers, each streamer including at least 2 hydrophones and at least a portion of a streamer is maintained at an angle to the sail line.

13. The method according to claim 12, wherein the angle is greater than 10°.

14. The method according to claim 1, wherein, in step (a), the at least one set of seismic traces is provided by sailing a vessel along a sail line while towing one or more streamers, each streamer including at least two hydrophones and each streamer is maintained substantially parallel to the sail line to produce for each bin a full offset range of seismic traces, and selecting a subset of the full range of seismic traces as each of the at least one set of seismic traces.
